(19) United States
(12) Patent Application Publication
(10) Pub. No.: US 2024/0257006 A1
(43) Pub. Date: Aug. 1, 2024

(54) Methods for Transmitting the Execution of a Working Task, Cooperation Module and Plant

(71) Applicant: Siemens Aktiengesellschaft, München (DE)

(72) Inventors: Markus Sauer, München (DE); Hubertus Hohl, Staufen (DE); Jochen Nickles, Fürth (DE); Ralph Büsgen, Großenseebach (DE); Joachim Feld, Nürnberg (DE)

(73) Assignee: Siemens Aktiengesellschaft, München (DE)

(21) Appl. No.: 18/560,827

(22) PCT Filed: May 11, 2022
(86) PCT No.: PCT/EP2022/062808

§ 371 Date: Nov. 14, 2023

(30) Foreign Application Priority Data
May 14, 2021 (DE) 10 2021 204 918.4
May 27, 2021 (EP) 21176234.9

(51) Int. Cl. G06Q 10/0631; G06Q 50/04

(52) U.S. Cl. CPC G06Q 10/06316; G06Q 50/04

(57) ABSTRACT

Various embodiments of the teachings herein include a method for communicating execution of a work task in an installation with two or more execution devices. The method may include: tendering execution of the work task to a plurality of execution devices for execution; querying a work effort of the respective execution devices for execution of the work task; selecting one of the plurality of execution devices on the basis of the queried work effort; and transferring execution of the work task to the selected execution device. The work effort includes an execution time and/or a resource expenditure.

### CROSS-REFERENCE TO RELATED APPLICATIONS

This application is a U.S. National Stage Application of International Application No. PCT/EP2022/062808 filed May 11, 2022, which designates the United States of America, and claims priority to EP Application No. 21176234.9 filed May 27, 2021 and DE Application No. 10 2021 204 918.4 filed on May 14, 2021, the contents of which are hereby incorporated by reference in their entirety.

### TECHNICAL FIELD

The present disclosure relates to execution of work tasks. Various embodiments of the teachings herein include systems and/or methods for communicating execution of a work task in an industrial installation with two or more execution devices, cooperation modules, and installations for executing work tasks.

### BACKGROUND

Execution devices for executing mechanical work tasks, in particular automated guided vehicles, also called AGVs for short, and autonomous mobile robots, also referred to as AMRs short, will play a central role in future logistics solutions. In terms of industry, AGVs are used, inter alia, in factory automation and, in the solutions business, are used in parcel and baggage logistics.

However, previous automation solutions with such execution devices can only be adapted to existing processes and solutions with a large amount of effort. In addition, available solutions are usually directly integrated in static automation solutions. The reconfiguration of execution devices in the form of production and manufacturing devices is also complicated. The dynamic, needs-based scaling of systems of execution devices and the process of dealing with system faults also require a large amount of manual effort.

### SUMMARY

The teachings of the present disclosure may be used to improve an adaptability of such solutions, in particular of automation solutions, and in particular to specify methods which can be used to distribute, that is to say communicate, the execution of work tasks, preferably mechanical or automated work tasks, in a more flexible manner and with a reduced amount of manual effort. The teachings provide a cooperation module which can be used to carry out such methods efficiently. For example, some embodiments include a computer-implemented method for communicating execution of a work task in an installation (ANL), in particular an industrial installation, with two or more execution devices (AVGE), in which the execution of the work task is tendered to a plurality of execution devices (AVGE) for execution by one of these execution devices (AVGE) in each case, and in which a work effort (C) of the respective execution devices (AVGE) for execution of the work task is queried, and in which one of the execution devices (AVGE) is selected on the basis of the queried work effort (C), and the execution of the work task is transferred to the selected execution device (AVGE), and in which the work effort (C) includes or makes up an execution time and/or a resource expenditure.

In some embodiments, that execution device (AVGE) which communicates the smallest work effort (C) for execution is selected to execute the work task.

In some embodiments, the execution devices (AVGE) are addressed by means of a communication network (CN) connecting the execution devices (AVGE) in order to tender the execution to the execution devices (AVGE) and to query the work effort.

In some embodiments, the work task comprises or represents transport processes and the execution devices (AVGE) are or have transport devices, in particular automated guided vehicles.

In some embodiments, the work effort (C) is measured in a work price.

In some embodiments, the method is initiated or carried out by means of a request device (AVGR) of the installation, wherein the request device (AVGR) is preferably also an execution device (AVGE).

As another example, some embodiments include a cooperation module for a request device, designed to carry out one or more of the methods for communicating a work task, having a request device interface (3) for connection to a request device (AVGR), wherein the request device interface (3) is designed to receive a signal from the request device (AVGR) signaling a need to execute a work task.

In some embodiments, the cooperation module is designed to select that execution device which communicates the smallest work effort (C) for execution, and/or is designed to execute an algorithm, according to which an execution device is selected on the basis of the queried work effort (C), to execute the work task.

In some embodiments, the cooperation module is in the form of a software module that is integrated in the request device (AVGR), in particular is installed on or in the request device (AVGR), or is in the form of a separate hardware module.

As another example, some embodiments include a cooperation module for an execution device (AVGE), designed to enable execution devices (AVGE) to participate in a method as claimed in one of the preceding claims, having an execution device interface (JEC) for connection to an execution device (AVGE), wherein the execution device interface (JEC) is designed to receive an ability of the execution device (AVGE) to execute the work task, and having a receiving interface (1) for receiving requests to execute the work task, a determination unit for determining (SCFJR2) a work effort (C) associated with the execution of the work task, and having an interface (1) for transmitting an offer to execute the work task plus effort information indicating the work effort (C) associated with the execution, wherein the cooperation module (CME) for an execution device (AVGE) simultaneously forms a cooperation module (CMR) for a request device, wherein the work effort (C) includes or makes up an execution time and/or a resource expenditure.

In some embodiments, the cooperation module for an execution device (AVGE) is in the form of a software module that is integrated in the execution device (AVGE), in particular is installed on the execution device (AVGE), or is in the form of a separate hardware module.

In some embodiments, the receiving interface (1) is designed to receive publish-subscribe messages, in particular filtered according to hardware of the request device (AVGR) connected to the execution device interface (JEC) or of the request device (AVGR) connected to the request device interface (3) and/or an execution device (AVGE).

In some embodiments, the execution device interface (JEC) is designed to receive a queue for work processes of the execution device (AVGE).

In some embodiments, the cooperation module includes a configuration interface (4) which is used to configure an algorithm, according to which an execution device is selected on the basis of the queried work effort (C).

As another example, some embodiments include an installation comprising two or more execution devices (AVGE) each with a cooperation module (CME) for an execution device (AVGE) as described herein, which is connected to the execution devices (AVGE), and comprising two or more request devices (AVGR) each with a cooperation module (CMR) for a request device (AVGR) as described herein, which is connected to the request devices (AVGR), in which the cooperation modules (CME) for an execution device (AVGE) that are connected to the execution devices (AVGE) and the cooperation modules (CMR) for a request device (AVGR) which are connected to the request devices (AVGR) are connected to one another by means of a communication network (CM) for the purpose of carrying out one or more of the methods described herein.

### BRIEF DESCRIPTION OF THE DRAWINGS

The teachings of the present disclosure are explained in more detail below on the basis of an exemplary embodiment which is indicated in the drawing, in which:

FIG. 1 is a drawing showing a basic schematic diagram of a cooperation network of an industrial installation having a request device and an execution device, to each of which a cooperation module incorporating teachings of the present disclosure is connected, designed to carry out a method incorporating teachings of the present disclosure;

FIG. 2 is a drawing showing a basic schematic diagram of the execution device with the cooperation module as shown in FIG. 1 connected thereto; and

FIG. 3 is a process diagram showing a method incorporating teachings of the present disclosure for communicating execution of a work task.

### DETAILED DESCRIPTION

The computer-implemented methods described herein may be used to communicate execution of a work task in an installation, in particular an industrial installation, with more than two execution devices. The execution of the work task is tendered to a plurality of execution devices for execution by these execution devices, and a work effort of the execution devices for execution of the work task is queried, and one of the execution devices is selected on the basis of the queried work effort, and the execution of the work task is assigned to the selected execution device.

Within the scope of the present disclosure, a work task should be understood as meaning a work task of a work method, in particular a transport task, and/or a manufacturing task. In particular, a work task should be understood as meaning one or more work steps and/or one or more manufacturing steps. In some embodiments, the work task is an automated and/or mechanical work task. In some embodiments, the execution device is an autonomous execution device which can execute a work task, in particular a mechanical and/or automated work task, after the work task has been assigned to this execution device, independently, that is to say autonomously, that is to say without central control of the execution of the work task.

The work effort of the execution devices is queried from the execution devices themselves, that is to say not by means of the execution devices. The execution devices expediently determine, in particular calculate, the work effort themselves in each case. The self-determined work effort of the execution devices can then be directly queried from the respective execution devices.

Distributed autonomous execution devices available in an industrial installation can collaborate with one another efficiently and in a resource-saving manner on an ad-hoc basis, in a demand-driven and context-dependent manner in a decentralized infrastructure and can therefore, as self-organizing execution devices, communicate and assign work tasks to one another for execution in a robust and self-organized manner. Central control of the execution devices or a centrally defined work plan for individual execution devices is not required in order to communicate work tasks to the respective execution devices.

The decentralized execution of work tasks which is communicated in a self-organized manner and is easily possible by means of the teachings herein allows the scaling of small systems to large systems. This is because the execution of work tasks which is communicated in a self-organized manner can be planned at the level of the execution devices, on account of the dispensable central planning, with the result that the otherwise required complexity of central planning is dispensed with on account of the self-organized communication.

In some embodiments, that execution device which communicates, that is to say transmits, the smallest work effort for execution when the work effort is queried is selected to execute the work task. In some embodiments, however, further criteria may also be included in order to select an execution device to execute the work task, for instance opportunity costs of the execution device for deferring other work processes or additional boundary conditions, in particular a maximum period which may be required overall by all of the work tasks.

In some embodiments, the execution devices are addressed by means of a communication network connecting the execution devices in order to tender the execution by the execution device and to query the work effort. In this manner, the execution devices can make direct contact with one another for collaborative cooperation by means of the communication network and can communicate the execution of the work task in a decentralized and efficient manner.

In the sense of the present disclosure, the communication network is a network used to communicatively connect the execution devices, and may also request devices described later, to one another. In some embodiments, the communication network is a wireless network, in particular a radio network. In some embodiments, the communication network is a cloud network and/or an Internet-of-Things network. In particular, Internet-of-Things networks and/or cloud networks are established in the industrial sector and can be used to carry out the methods described herein in a manner known.

In some embodiments, the work task is one or more transport processes. In some embodiments, the execution devices are also transport devices, in particular automated guided vehicles, or the execution devices have such transport devices. Especially with respect to transport processes using automated guided vehicles, work tasks, that is to say transport processes or partial transport processes, can fundamentally be carried out autonomously. Accordingly, transport processes can be communicated and distributed as work tasks in a particularly flexible manner and without any manual effort, with the result that the method according to the invention can be implemented in a particularly efficient manner in this development. In some embodiments, the execution devices are mobile robots.

In some embodiments, the work effort includes or makes up an execution time and/or a resource expenditure. The execution time and/or the resource expenditure needed to execute the work tasks is/are, in particular, usually relevant process parameters in industrial work processes, for instance in manufacturing processes. Consideration of these process parameters can optimize the performance of the methods with regard to these process parameters.

In some embodiments, state parameters of the execution devices may be alternatively or additionally included in the work effort. In particular, a current level of operating hours of the execution devices and/or a length of queues of planned work processes of the execution devices and/or an internal energy reserve of the respective execution device is/are such state parameters. A scarce energy reserve of the execution device, as a scarce resource, may result in an amount of energy to be expended for a work task being classified as a greater amount of work effort than the same amount of energy if there is a surplus energy reserve.

In some embodiments, the work effort is measured in a work price. In this development, formation of a work price can be used to efficiently distribute the work tasks among the execution devices. The work price can therefore be used as a simple, one-dimensional measure or currency for selecting a specific execution device. If, for instance, the work price of an execution device for executing a task is particularly high on account of a queue for the execution device with a particularly large number of high-priority work tasks of the execution device, execution devices whose queues have a smaller number of work tasks are more likely to be selected on account of the high work price. Therefore, pricing of the work effort can reduce task congestion and distribution of work tasks to execution devices having scarce resources for executing work tasks and overall can achieve a higher degree of efficiency when distributing the work tasks.

In some embodiments, the method is initiated, triggered, or carried out by means of a request device of the collaborative, in particular industrial, network, wherein the request device is simultaneously an execution device. In some embodiments, the request device is in turn an execution device for work tasks which are communicated by further request devices for execution by means of the methods herein.

The cooperation module for a request device is designed to carry out a method for communicating a work task as described above and has a request device interface for connection to a request device. In the cooperation module for the request device, the request device interface is designed to receive a signal from the request device signaling a need to execute a work task. The cooperation module is designed to carry out the method when it receives the signal from the request device. The request device can therefore carry out the method according to the invention for communicating execution of a work task by means of the cooperation module for a request device.

The cooperation module for an execution device is designed for use in a method and has an execution device interface for connection to an execution device as described above. In some embodiments, the cooperation module for a request device is in the form of a software module that is integrated in the request device, in particular is installed in or on the request device.

In some embodiments, the cooperation module for an execution device is designed for use in a method as described above and has an execution device interface for connection to an execution device, wherein the execution device interface is designed to receive an ability of the execution device to execute a work task. The cooperation module for an execution device also has a receiving interface for receiving requests to execute the work task. The cooperation module for an execution device also comprises a determination unit for determining, e.g. previously determining, a work effort associated with the execution of the work task, and a transmitting interface for transmitting an offer to execute the work task plus effort information indicating the work effort associated with the execution.

Execution devices such as AGVs and AMRs, but also other execution devices such as devices and machines used for work methods or manufacturing methods, can be enabled, by means of the cooperation module for an execution device, to execute work tasks in a decentralized infrastructure efficiently and in a resource-saving manner on an ad-hoc basis, in a demand-driven and context-dependent manner. In addition, request devices can be enabled, by means of the cooperation module according to the invention for a request device, to coordinate work tasks efficiently and in a resource-saving manner.

The method for communicating a work task can be particularly easily implemented by means of a “plug-and-perform” approach using the cooperation module for an execution device. In principle, execution devices which do not cooperate with one another in a self-organized manner can be easily upgraded or retrofitted for self-organized collaboration by means of the cooperation module according to the invention for an execution device. Consequently, the execution devices can be enabled to carry out the methods for communicating work tasks by means of the cooperation module for an execution device.

The cooperation module for an execution device need not be identical to a cooperation module for a request device. However, the cooperation module for an execution device may be simultaneously a cooperation module for a request device. In this manner, an execution device, for instance, can undertake a work task by means of the cooperation module and can forward the work task if necessary, for instance, if it is unexpectedly not possible to execute the work task or if a partial task of the work task is intended to be assigned as a subtask. The cooperation module for an execution device then allows, when simultaneously designed as a cooperation module for a request device, the methods to be carried out, in which the work task or a part of the work task is communicated to further execution devices.

In some embodiments, the cooperation module for an execution device is in the form of a software module that is integrated in the execution device, in particular is installed on the execution device.

The execution and request devices equipped with the cooperation module for an execution device or equipped with the cooperation module for a request device are enabled as so-called agents in a network of agents on account of the connection of the cooperation module for an execution device or the cooperation module for a request device: in this network, individual agents can assume the roles of the execution device and request devices with the aid of the cooperation module for an execution device or the cooperation module for a request device.

In the role of a request device, the agent can request, that is to say order, execution of work tasks, for instance transportation, and for this purpose puts the work task, which is intended to be executed, with certain parameters into the network of the agents. These parameters may be, in particular, conditions imposed on the execution, expediently a type of transport, and/or restrictions, expediently a type of vehicle, and/or parameters of the assignment method, preferably an assignment algorithm and/or assignment parameters.

In some embodiments, the assignment algorithm is an auction for the execution of the work task: in the role of an execution device, the agent waits for tendered execution of the work task that matches its abilities and participates in a corresponding assignment method according to the assignment algorithm. After the work task has been assigned, the agent executes the work task, as tendered, that has been assigned to it with the assignment.

In some embodiments, execution devices and request devices can be implemented using the same device. In some embodiments, a device which forms an execution device can also in turn request resources for assisting with the execution of the work task from further execution devices and can therefore delegate or transfer partial tasks in the form of execution of work subtasks to other execution devices.

In some embodiments, the cooperation module for a request device is configured to carry out one or more of the methods described herein using software. In some embodiments, however, the cooperation module may also be designed and configured to carry out the method using a logic circuit.

In some embodiments, the cooperation module for an execution device and/or the cooperation module for a request device is/are each a software module. The cooperation module can be executed as a software module on execution devices and/or request devices in the form of edge computing devices and/or embedded devices or programmable logic modules, in particular programmable logic control units, e.g. PLCs (programmable logic controllers), or smartphones or tablets.

In some embodiments, the cooperation module is in the form of a separate hardware module. The cooperation module can be connected to an execution device and/or a request device, in particular in order to form an installation as described below and/or in order to carry out the methods as described above. In this manner, execution devices and request devices can be retrofitted with the cooperation modules for a request device and/or an execution device for the purpose of carrying out the methods described herein.

In some embodiments, this module is configured to translate abilities of the execution devices to execute the work task and special features of the communication of the execution device into a form that can be understood by all other cooperation modules CME, CMR of the cooperation network CN and to abstract them from the details of the respective execution device. In this manner, cooperation modules which are connected to one another can be used to form a cooperation network which hides the individual communication properties of individual execution devices and the possibly differing descriptions of abilities of the respective execution device. The cooperation modules can therefore be used to set up a cooperation network in which the execution of work tasks can be tendered and understood in a consistent manner and special features of the individual execution and request devices do not need to be individually addressed at the network level of the cooperation network.

In the cooperation module for an execution device, the receiving interface is suitably configured to receive or transmit requests in the form of publish-subscribe messages, in particular specifically according to the abilities of the execution device connected to the execution device interface. Publish-subscribe messages can be used to easily tender the execution of the work task. Therefore, not all execution devices need to constantly communicate with all request devices in a direct connection to one another, but rather it suffices if execution devices only subscribe to those messages which relate to themselves. Execution devices may therefore only subscribe to those publish-subscribe messages which relate to work tasks that can be executed by the execution devices themselves. Furthermore, the work effort can also be communicated in each case using publish-subscribe messages.

In some embodiments, in the cooperation module, the execution device interface is designed to receive a queue of planned work processes of the execution device. This makes it possible to easily integrate newly assigned work tasks in the queue of planned work processes.

In some embodiments, the cooperation module for a request device has a configuration interface which is used to configure an algorithm, according to which an execution device is selected on the basis of the queried work effort. Such an algorithm may be an assignment algorithm as explained above which provides, in particular, for executions of work tasks to be tendered and auctioned. Furthermore, other algorithms may also be configured using the configuration interface.

The installation comprises two or more execution devices each with a cooperation module for an execution device as described above, which is connected to the execution devices, and the installation also comprises two or more request devices each with a cooperation module for a request device as described above, which is connected to the request devices. In the installation, the cooperation modules of the execution devices and of the request devices are connected to one another by means of a communication network for the purpose of carrying out a method for communicating execution of a work task as described above.

In some embodiments, the installation comprises an industrial installation, in particular a manufacturing installation and/or a processing installation.

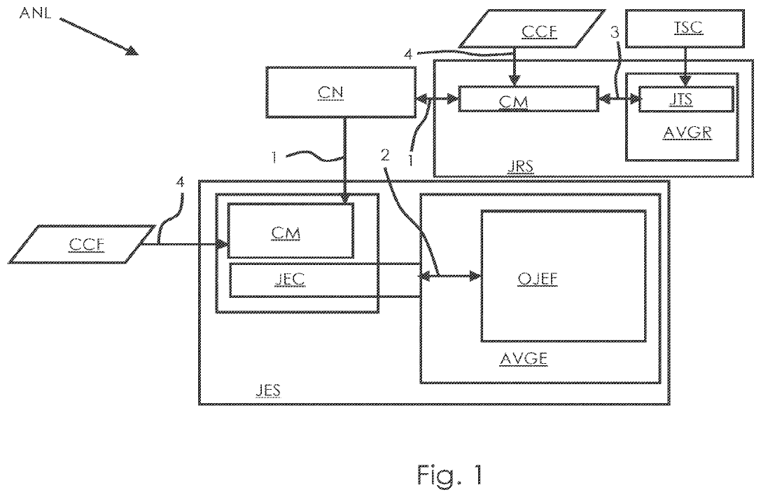

FIG. 1 is a drawings showing, by way of example, cooperation of execution systems JES for executing work tasks and of request systems JRS for requesting work tasks, each comprising an automated guided vehicle AVGE or AVGR. In this case, the automated guided vehicle of the execution system JES forms an execution device AVGE in the sense of the present disclosure. Accordingly, the automated guided vehicle of the request system JRS forms a request device AVGR.

The execution system JES for executing work tasks and the request system JRS for requesting JR work tasks are part of a cooperation network CN of an installation ANL incorporating teachings of the present disclosure, in particular an industrial installation. In this case, the cooperation network CN has a plurality of execution systems JES for executing work tasks and a plurality of request systems JRS for requesting JR work tasks. Work tasks which are requested by the request systems JRS and are executed by the execution systems JES are communicated by means of the cooperation network CN.

The execution system JES for executing work tasks has a cooperation module CME according to the invention for an execution device AVGE of the execution system JES in order to provide the work functions JEF of the execution system JES which are available for the work tasks in the cooperation network CN. The cooperation module CME for an execution device AVGE (also called cooperation module for short below) is configured via a configuration interface 4 using a cooperation configuration file CCF. The cooperation module CME forms, together with the execution device AVGE, the execution system JES.

These work functions OJEF of the automated guided vehicle of the execution system JES for executing work tasks are available for the cooperation module CME via a generic execution interface JEC that is specifically adapted to the respective specific vehicle type of the automated guided vehicle. The execution interface JEC can be programmed by means of an execution connection interface 2b which forms a programming interface. The execution interface JEC is connected to the work functions OJEF by means of a work function interface 2. The cooperation module CME can therefore access the work functions OJEF of the execution device AVGE via the work function interface 2 and the execution interface JEC.

The request system JRS for requesting work tasks likewise has a cooperation module CMR, albeit a cooperation module for a request device AVGR, which can be used to request the execution of work tasks in such a manner that the cooperation module CMR sets a work task by means of a tender to execute a work task by the execution systems JES in the cooperation network CN. The cooperation module CMR for a request device AVGR is likewise referred to as a cooperation module CMR for short below.

For this purpose, the request system JRS transmits the work task to its cooperation module CMR via the request interface 3. In this case, the request system JRS determines a need for execution of a work task by means of a need determination system JTS which is configured by means of a need determination configuration TSC. If a need to execute a work task is determined, the need determination system JTS transmits the required work task to the cooperation module CMR via the request interface 3. The cooperation module CMR is configured via a configuration interface 4 using a cooperation configuration file CCF.

The cooperation configuration file additionally contains an algorithm, according to which the execution device AVGE is selected on the basis of the queried work effort, in the exemplary embodiment illustrated an auction algorithm in which that execution device AVGE which determines the smallest work effort is selected. The execution systems JES with the cooperation module CME and the request systems JRS with the cooperation module CME then communicate for self-organization using a cooperation protocol by means of the network interfaces 1 via the cooperation network CN.

The cooperation module CMR forms, together with the request device AVGR, the request system JRS. The cooperation modules CMR, CME are each implemented as a software module and are connected to the execution device AVGE via the execution interface JEC or to the request device AVGR via the request interface 3 in order to form the execution system JES and the request system JRS as a plug-and-perform component.

In some embodiments, the cooperation modules CME, CMR may also be implemented as a separate apparatus which is connected to the request device AVGR in the form of additional hardware.

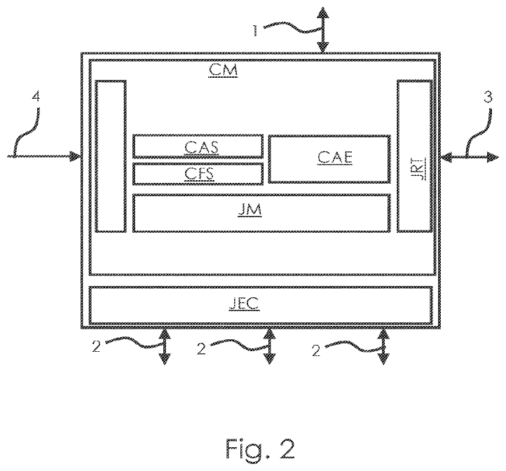

In addition to the request interfaces 3 and the execution interfaces JEC which are used to incorporate the cooperation modules CME, CMR in the execution systems JES and in the request systems JRS, further additional functional modules of the cooperation module CME are illustrated in FIG. 2. The cooperation module CME in FIG. 2 is connected to an execution device AVGE in order to form an execution system JES.

The cooperation module CME therefore has a memory CAS containing cooperation algorithms, wherein the cooperation algorithms may be incorporated as plug-in components. The cooperation algorithms determine the interaction sequence of execution systems JES and request systems JRS and the self-organization method. For example, the cooperation algorithms are in the form of an auction method in which execution systems JES submit an offer to execute the work task on the basis of their cost calculation. In these cooperation algorithms, the request systems JRS decide, after the expiry of a particular offer period, which offer from an execution system JES can be accepted at the lowest costs C. This offer to execute the work task from the execution system JES is then definitively assigned to the execution system JES, that is to say the work task is ordered from the relevant execution system JES with the lowest costs C.

The cooperation module CME also has a configurable cost function memory CFS containing cost functions CF. The cost functions CF are likewise algorithms which are implemented as a plug-in component and use configurable parameters of the execution system JES to determine what the costs C would be for this execution system JES to fulfill a request JR to execute the work task. These parameters may result from various circumstances, in particular from a system state or from potential order expenditures or environmental states.

A cooperation algorithm execution component CAE processes incoming requests to execute work tasks or outputs requests to execute work tasks to the communication network CN. The assignment is effected on the basis of the configuration of the cooperation module CMR of the request system JRS and of the selected cooperation algorithm for requesting the execution of the work task.

The request management module JM manages all requests to execute work tasks which relate to this entity of the cooperation module CME. This management comprises processes in the form of monitoring the status of requests, managing queues of requests and initiating actions on the basis of results of one or more of the above-mentioned management processes, and processes which comprise error and escalation management or a communication of status updates to other cooperation modules CMR.

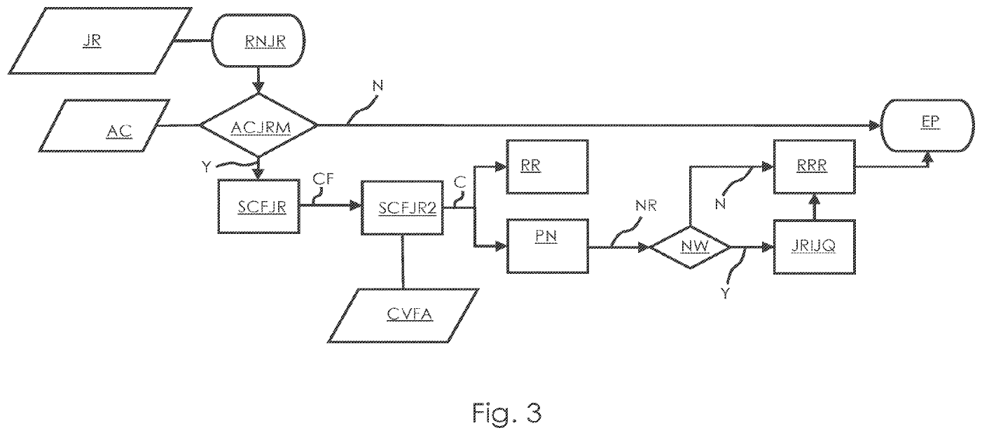

FIG. 3 shows an exemplary embodiment of cooperation algorithms and their execution on an execution system JES. The cooperation algorithms of execution systems JES are executed by means of the cost functions CF of the cost memory CFS and by means of the coordination algorithms from the memory CAS of the cooperation module CME, as shown in the exemplary embodiment of the automated guided vehicle according to FIG. 2. In this case, the cooperation algorithms are executed in a decentralized manner on those automated guided vehicles AGVE which are available in execution systems JES, as illustrated in FIG. 3.

The execution system JES first of all receives a request JR for a work task from a request system JRS. The request JR for the work task comprises both a defined work result and work instructions needed to execute the work task and requirements to be met.

If the execution system JES receives the request JR for the work task in a process step RNJR, a check is carried out in a further process step ACJRM in order to determine whether the execution system has the appropriate abilities AC to execute the work task. If the result of the check is negative N, the further processing of the request JR for the work task is terminated in a process step EP.

If the result of the check is positive Y, a cost function CF for quantifying the work effort is selected in a process step SCFJR on the basis of the request JR for the work task. The cost function CF is now used to determine the costs C in a process step SCFJR2. Cost values CVFA of the respective automated guided vehicle AGV which are stored in the respective cooperation module CME are used for this purpose. Depending on the costs C, resources for executing the work task that has been requested with the request JR for the work task are possibly also reserved in a process step RR.

With the costs C determined using the cost function CF, the cooperation module CME of the execution system JES begins a negotiation NR by transmitting its costs C, by means of a transmission process PN, to the cooperation module CME of that request system JRS which has put the request JR for the work task into the cooperation network CN. A check is then carried out in a process step NW in order to determine whether the execution system JES has one the negotiation NR, that is to say the result from the request system JRS tendering the work task is queried in order to determine whether the execution system JES can offer the lowest costs C for executing the work task in the request JR. If the result of this check is negative N, the resources reserved in a work task RRR for executing the work task in the request JR are released again. In this case too, the execution of the self-organization functions is terminated with a process step EP.

If the checking in the process step NW results in a positive response Y, the execution system JES has successfully negotiated the execution of the work task in the request JR for itself and the work task in the request JR is incorporated in a process step JRIJQ into a queue of work processes to be executed by the execution system JES.

In some embodiments, the cooperation module CME is exclusively physically connected to the other hardware of the execution system JES. Thus, the cooperation module CME is integrated in the execution system JES, for example using a cable, via which standardized physical communication takes place. In this manner, existing autonomous systems can be enabled, by means of “plug and perform”, to undertake requested work tasks in a self-organized manner.

In some embodiments, the cooperation module CME for an execution device AVGE is simultaneously designed and configured as a cooperation module CMR for a request device AVGR.

The above-described exemplary embodiments for communicating the execution of work tasks should be understood merely as an example. The invention can also be advantageously used in a multiplicity of other application domains, for example in intelligent manufacturing.

In some embodiments, the cooperation network has a heterogeneous owner and operator structure. This means that the execution systems JES are operated by different operators. The owners of different execution systems JES also differ. The communication of the execution of work tasks and the actual selection of the execution system JES are carried out using cryptographic methods and signatures, for example in a decentralized database such as a blockchain and/or by means of smart contracts. In this exemplary embodiment, the transaction security and auditability are protected by means of cryptographic methods and/or by means of smart contracts.

What is claimed is:

1. A method for communicating execution of a work task in an installation with two or more execution devices, the method comprising:
tendering execution of the work task to a plurality of execution devices for execution;
querying a work effort of the respective execution devices for execution of the work task;
selecting one of the plurality of execution devices on the basis of the queried work effort; and
transferring execution of the work task to the selected execution device;
wherein the work effort includes an execution time and/or a resource expenditure.

2. The method as claimed in the preceding claim, wherein selecting one of the plurality of execution devices includes identifying the execution device which communicates a smallest work effort to execute the work task.

3. The method as claimed in claim 1, wherein the execution devices are addressed using a communication network connecting the execution devices to tender the execution to the execution devices and to query the work effort.

4. The method as claimed in claim 1, wherein:
the work task comprises transport processes; and
the execution devices comprise transport devices.

5. The method as claimed in claim 1, wherein the work effort indicates a work price.

6. The method as claimed in claim 1, initiated or carried out by a request device of the installation;
wherein the request device comprises one of the plurality of execution devices.

7. A cooperation module for a request device, the cooperation module comprising:
a request device interface to connect to a request device;
wherein the request device interface receives a signal from the request device signaling a need to execute a work task.

8. The cooperation module for a request device as claimed in claim 7, configured to:
select an execution device communicating a smallest relative work effort for execution; and/or
execute an algorithm, according to which an execution device is selected on the basis of the queried work effort, to execute the work task.

9. The cooperation module for a request device as claimed in claim 7, comprising a software module integrated in the request device or a separate hardware module.

10. A cooperation module for an execution device, designed to enable execution devices to participate in work task assignment, comprising:
an execution device interface to connect to an execution device, the execution device interface designed to receive an ability of each execution device to execute a work task;
a receiving interface to receive requests to execute the work task;
a determination unit to determine a work effort associated with the execution of the work task; and
an interface to transmit an offer to execute the work task plus effort information indicating the work effort associated with the execution;
wherein the cooperation module for an execution device simultaneously forms a cooperation module for a request device;
wherein the work effort includes an execution time and/or a resource expenditure.

11. The cooperation module for an execution device as claimed in claim 10, in the form of a software module integrated in the execution device or a separate hardware module.

12. The cooperation module for an execution device claimed in claim 10, wherein the receiving interface is configured to receive publish-subscribe messages, filtered according to hardware of the request device connected to the execution device interface or of the request device connected to the request device interface and/or an execution device.

13. The cooperation module for an execution device as claimed in claim 10, wherein the execution device interface is designed to receive a queue for work processes of the execution device.

14. The cooperation module for a request device as claimed in claim 10, further comprising a configuration interface used to configure an algorithm, according to which an execution device is selected on the basis of the queried work effort.

15. An installation comprising:
two or more execution devices each with a cooperation module connected to the execution devices; and
two or more request devices each with a cooperation module connected to the request devices;
wherein the cooperation modules connected to the execution devices and the cooperation modules connected to the request devices are connected to one another by a communication network.
